(19) United States
(12) Patent Application Publication
(10) Pub. No.: US 2025/0085760 A1
(43) Pub. Date: Mar. 13, 2025

(54) COMMUNICATION SYSTEM

(71) Applicant: CANON KABUSHIKI KAISHA, Tokyo (JP)

(72) Inventor: HIDEAKI OHSHIMA, Kanagawa (JP)

(21) Appl. No.: 18/826,795

(22) Filed: Sep. 6, 2024

(30) Foreign Application Priority Data
Sep. 8, 2023 (JP) 2023-145934

(51) Int. Cl. G06F 1/3209; G06F 1/3228

(52) U.S. Cl. CPC G06F 1/3209; G06F 1/3228

(57) ABSTRACT

In a communication system, a first communication apparatus includes a communication unit that transmits request information for switching a Wake On Lan (WOL) function to an enabled or disabled state and an activation packet to the second communication apparatus based on instruction information set by a user, and a second communication apparatus includes a communication unit that receives the request information and the activation packet from the first communication apparatus, and a control unit that switches the WOL function to the enabled or disabled state based on the request information, wherein, in a case where the activation packet is received when an operation state of the second communication apparatus is a power saving state and the WOL function is enabled, the control unit performs processing for activating the second communication apparatus from the power saving state and switches the WOL function of the second communication apparatus to the disabled state.

### BACKGROUND

### Field of the Disclosure

The present disclosure relates to a communication system for an external device terminal and a communication apparatus, and in particular to a communication system that performs remote control.

### Description of the Related Art

As means for restoring an information device, such as a personal computer (PC), in a sleep state to an activated state by remote operation, Wake On Lan (hereinafter, referred to as WOL) has been conventionally used. In a case of using the WOL in remote operation, it is necessary to previously perform a setting in an information device, such as a PC, in order to enable a WOL function. Thus, if the setting of the WOL is cleared for some reason, the WOL becomes unusable by the remote operation. A function for dealing with such a case has been provided. For example, a technique for returning an information device to a state where the information device can be turned on by the WOL even if an external power supply is shut off in a state where the WOL function is set is discussed (Japanese Patent Application Laid-Open No. 2016-122436).

In the existing technique discussed in Japanese Patent Application Laid-Open No. 2016-122436, the WOL setting information is managed, and at a time of shutdown, the WOL setting is performed based on the information managed and the apparatus is transitioned to a standby state. At this time, WOL setting enabled information is stored, and the WOL setting is enabled thereafter, and thus, the WOL setting is performed irrespective of a connection partner.

### SUMMARY

The present disclosure is directed to a technique for setting WOL setting information on a communication apparatus from an external device terminal at a timing intended by a user, and for enabling only a set communication partner to restore the communication apparatus to an activated state by remote operation using the WOL.

According to an aspect of the present disclosure, a communication system includes a first communication apparatus and a second communication apparatus, wherein the first communication apparatus includes a communication unit configured to transmit request information for requesting to switch a Wake On Lan (WOL) function to an enabled state or a disabled state and an activation packet to the second communication apparatus based on instruction information set by a user, wherein the second communication apparatus includes a communication unit configured to receive the request information and the activation packet from the first communication apparatus, and a control unit configured to switch the WOL function to the enabled state or the disabled state based on the request information received from the first communication apparatus, and wherein, in a case where the activation packet is received when an operation state of the second communication apparatus is a power saving state and the WOL function is enabled, the control unit performs processing for activating the second communication apparatus from the power saving state and switches the WOL function of the second communication apparatus to the disabled state.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a communication apparatus according to one or more aspects of the present disclosure.

FIG. 2 is a block diagram illustrating a configuration of an external device terminal according to one or more aspects of the present disclosure.

FIG. 3 is a conceptual diagram according to one or more aspects of the present disclosure.

FIG. 4 is a flowchart illustrating processing to be performed by the communication apparatus according to one or more aspects of the present disclosure.

FIG. 5 is a flowchart illustrating processing to be performed by the external device terminal according to one or more aspects of the present disclosure.

FIG. 6 is a flowchart illustrating processing to be performed by the communication apparatus according to one or more aspects of the present disclosure.

FIG. 7 is a flowchart illustrating processing to be performed by the external device terminal according to one or more aspects of the present disclosure.

### DESCRIPTION OF THE EMBODIMENTS

Some exemplary embodiments of the present disclosure are described in detail below with reference to accompanying drawings. The exemplary embodiments described below are examples as means for implementing the present disclosure, and may be appropriately corrected or changed depending on a configuration of an apparatus to which the present disclosure is applied and various kinds of conditions. Further, the exemplary embodiments can be appropriately combined.

In the following, an exemplary embodiment in which a communication apparatus according to the present disclosure is mounted on an imaging apparatus, such as a digital camera, is described; however, the communication apparatus is not limited thereto. The communication apparatus according to the present disclosure can be applied to a mobile phone, a portable media player, a tablet device, and an information processing apparatus, such as a personal computer.

In each of the exemplary embodiments, a personal computer (hereinafter, PC) is described as an example of an external device terminal; however, the external device terminal is not limited thereto. The external device terminal according to the present disclosure can be similarly applied to a mobile phone, a portable media player, a tablet device, and an information processing apparatus, such as a personal computer.

In the following, an example in which the external device terminal (i.e., PC) is an example of a first communication apparatus and the communication apparatus (i.e., imaging apparatus, such as digital camera) is an example of a second communication apparatus is mainly described; however, the first communication apparatus and the second communication apparatus may be interchanged.

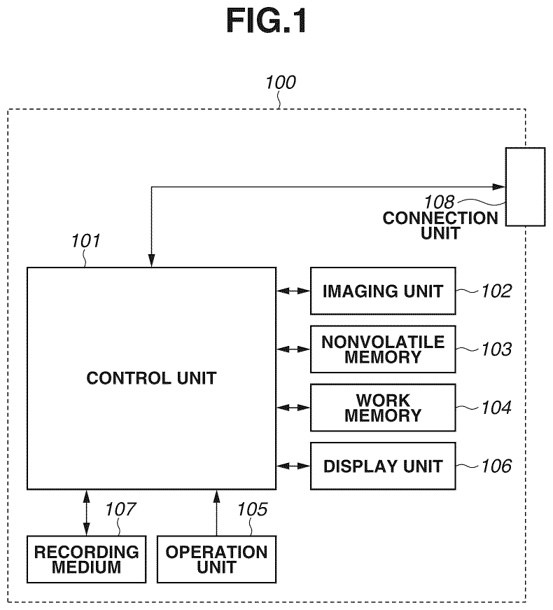

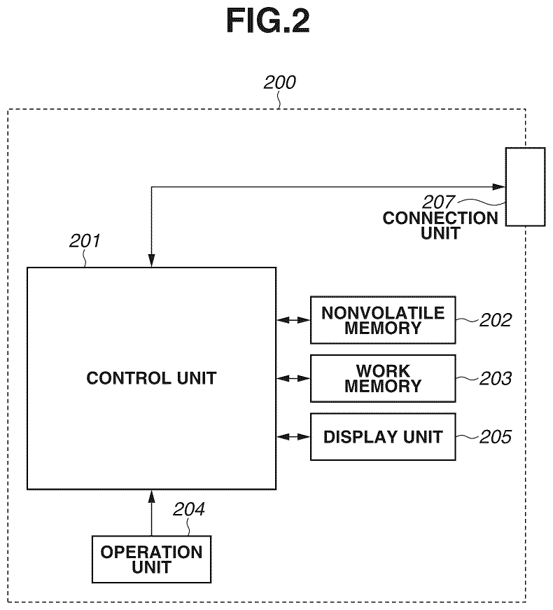

Outlines of configurations and functions of the imaging apparatus and the personal computer constituting a communication system according to the exemplary embodiments of the present disclosure are described with reference to FIG. 1 and FIG. 2.

In FIG. 1, a control unit 101 controls units of an imaging apparatus 100 based on input signals and programs described below. In place of the control unit 101 controlling the entire apparatus, a plurality of pieces of hardware may share the processing to control the entire apparatus. The imaging apparatus 100 operates at least in an activated state and in a power saving state.

An imaging unit 102 converts object light formed by a lens included in the imaging unit 102 into an electric signal, performs noise reduction processing and the like, and outputs digital data as image data. The captured image data is subjected to predetermined calculation by the control unit 101 after being stored in a buffer memory, and then recorded in a recording medium 107.

A nonvolatile memory 103 is an electrically erasable/recordable nonvolatile memory, and stores programs (described below) to be executed by the control unit 101, and the like.

A work memory 104 is used as a buffer memory for temporarily storing image data captured by the imaging unit 102, an image display memory for a display unit 106, a work area for the control unit 101, and the like.

An operation unit 105 is used to receive a user instruction related to the imaging apparatus 100 from a user. The operation unit 105 includes operation members such as a power button for the user to issue an instruction to turn-on/off a power supply of the imaging apparatus 100, a release switch for the user to issue an instruction to perform imaging, and a reproduction button for the user to issue an instruction to reproduce image data. A touch panel formed on the display unit 106 (described below) is also included in the operation unit 105. The release switch includes switches SW1 and SW2. When the release switch is so-called half pressed, the switch SW1 is turned on. In response to the switch SW1 half pressed, an instruction for performing imaging preparation, such as automatic focus (AF) processing, automatic exposure (AE) processing, automatic white balance (AWB) processing, and electronic flash pre-emission (EF) processing, is received. When the release switch is so-called fully pressed, the switch SW2 is turned on. In response to the switch SW2 fully pressed, an instruction for performing imaging is received.

The display unit 106 displays a viewfinder image during imaging, captured image data, characters for an interactive operation screen, and the like. The display unit 106 is not necessarily incorporated in the imaging apparatus 100. It is sufficient for the imaging apparatus 100 to be connected to the display unit 106 internally or externally, and to have at least a display control function of controlling display of the display unit 106.

The recording medium 107 can record the image data output from the imaging unit 102.

The recording medium 107 may be configured to be attached to and detached from the imaging apparatus 100, or may be incorporated in the imaging apparatus 100. In other words, it is sufficient for the imaging apparatus 100 to have at least means for accessing the recording medium 107.

A connection unit 108 is a communication unit incorporated in a main body of the imaging apparatus 100. The control unit 101 controls the connection unit 108 to implement communication with an external apparatus. The communication method is a wireless local area network (LAN), a wired LAN, and the like.

In FIG. 2, a control unit 201 controls an entire PC 200 by executing control programs held in a nonvolatile memory 202.

The nonvolatile memory 202 is a nonvolatile memory storing the above-described programs and the like.

A work memory 203 is a volatile memory used as a work area when the control unit 201 executes the control programs. The work memory 203 is also used as an area temporarily buffering data when the PC 200 communicates with the imaging apparatus 100 via a connection unit 207.

A display unit 205 outputs a display screen when the control programs are executed.

An operation unit 204 is used to receive a user instruction related to the PC 200 from the user. The operation unit 204 includes, for example, a keyboard and a mouse.

The connection unit 207 is a communication unit incorporated in a main body of the PC 200. The control unit 201 controls the connection unit 207 to implement communication with the imaging apparatus 100. The communication method is a wireless LAN, a wired LAN, and the like.

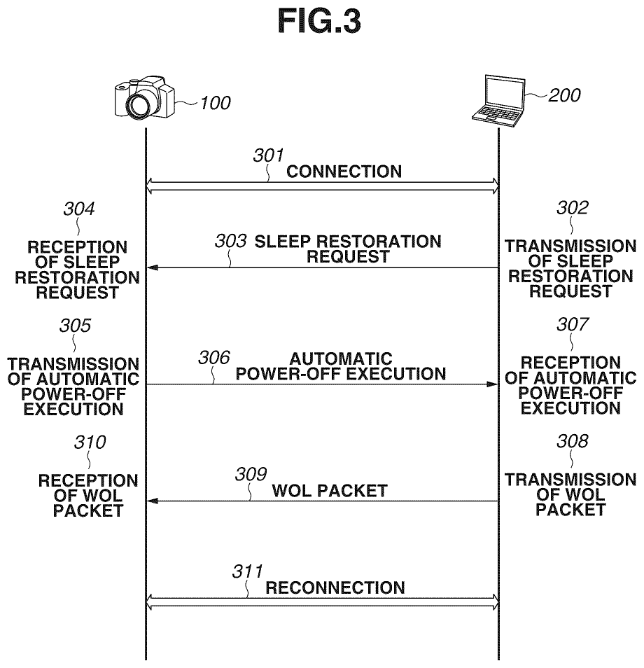

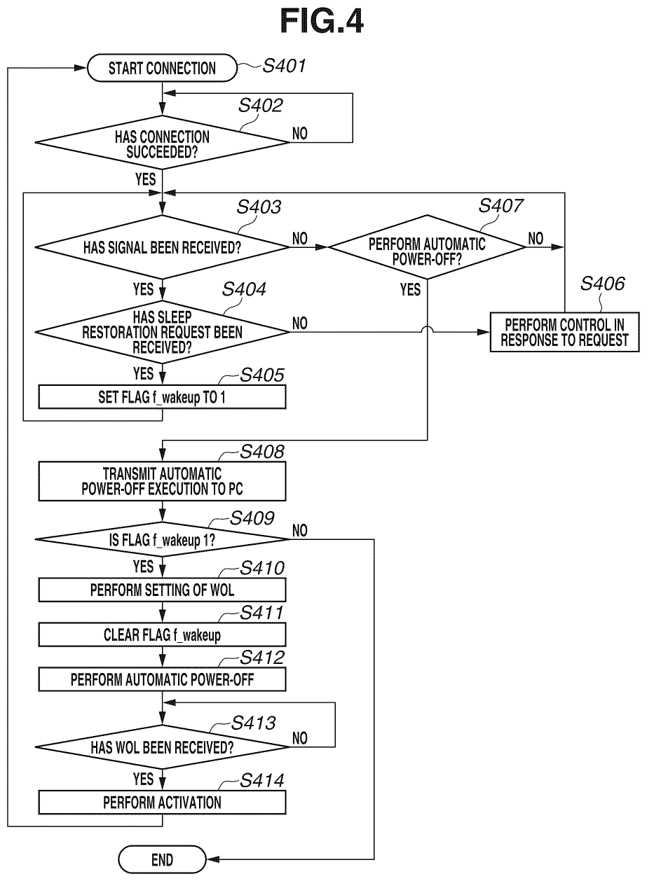

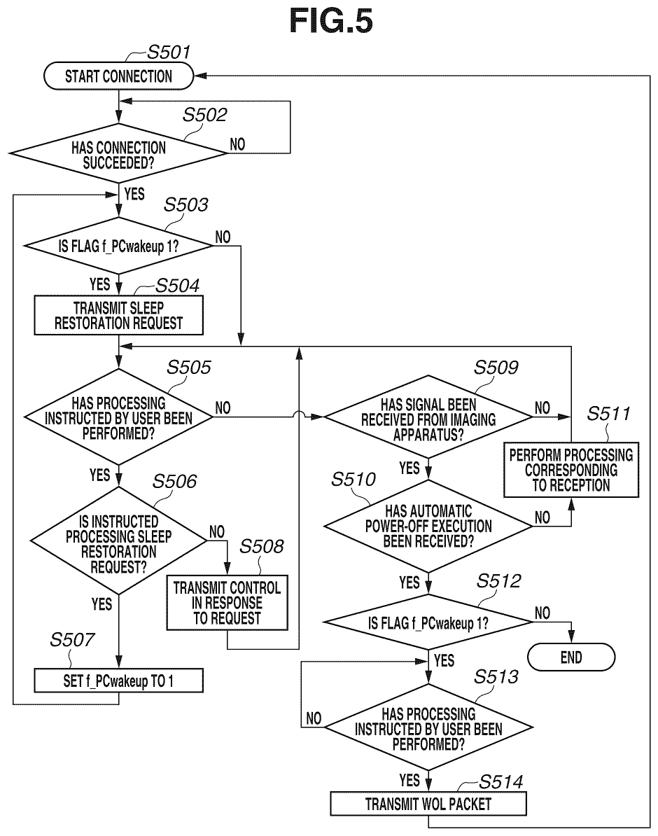

Communication between the imaging apparatus 100 and the PC 200 and a flow of processing to be performed in each of the apparatuses according to a first exemplary embodiment of the present disclosure are described with reference to FIGS. 3, 4, and 5.

### [Processing in Imaging Apparatus 100]

In step S401, the control unit 101 starts a connection with the PC 200 via the connection unit 108. Thereafter, the processing proceeds to step S402.

In step S402, the control unit 101 performs connection operation to connect with the PC 200 via the connection unit 108, and determines whether the connection has succeeded. The connection operation includes establishment of a link of the connection unit 108, logical establishment of a communication protocol via the connection unit 108, and the like.

In FIG. 3, a connection 301 between the imaging apparatus 100 and the PC 200 is established. In a case where the connection has succeeded (YES in step S402), the processing proceeds to step S403.

In step S403, the control unit 101 determines whether any signal has been received from the PC 200 via the connection unit 108. In a case where a signal has been received (YES in step S403), the processing proceeds to step S404. In a case where no signal has been received (NO in step S403), the processing proceeds to step S407.

In step S404, the control unit 101 determines whether the signal received from the PC 200 in step S403 is a sleep restoration request. In a case where the received signal is a sleep restoration request (YES in step S404), the processing proceeds to step S405. In a case where the received signal is not a sleep restoration request (NO in step S404), the processing proceeds to step S406. The sleep restoration request is an example of request information.

In FIG. 3, in a case where a sleep restoration request 303 is transmitted from the PC 200 in an operation 302, the imaging apparatus 100 receives the sleep restoration request 303 via the connection unit 108 in an operation 304.

In step S405, in the case where the signal received from the PC 200 is a sleep restoration request in step S404, the control unit 101 sets a flag f_wakeup to 1 (f_wakeup=1), and the processing proceeds to step S403.

The flag f_wakeup is a flag for determining whether the sleep restoration request has been issued from the PC 200. The flag f_wakeup is initialized to 0 (f_wakeup=0) at the start of the connection. The flag f_wakeup is stored in the work memory 104.

In step S406, in the case where the signal received from the PC 200 is not a sleep restoration request in step S404, the control unit 101 performs control appropriate for the received request. After the control appropriate for the received request is performed, the processing proceeds to step S403. Examples of a request other than the sleep restoration request may include an imaging request and an imaging parameter change request. In other words, the request is a request for remotely operating the imaging apparatus 100 from the PC 200.

In step S407, in a case where no signal has been received from the PC 200 in step S403, the control unit 101 determines whether to perform automatic power-off. In a case where the automatic power-off is to be performed (YES in step S407), the processing proceeds to step S408. In a case where the automatic power-off is not to be performed (NO in step S407), the processing proceeds to step S403.

In step S408, the control unit 101 transmits an event of automatic power-off execution to the PC 200 via the connection unit 108. After the transmission, the processing proceeds to step S409.

In FIG. 3, automatic power-off execution 306 is transmitted to the PC 200 via the connection unit 108 in an operation 305. The PC 200 receives the automatic power-off execution 306 via a communication path in an operation 307, and recognizes the event in which the imaging apparatus 100 executes the automatic power-off.

In step S409, the control unit 101 determines whether the flag f_wakeup is 1. In a case where the flag f_wakeup is 1 as a result of the determination (YES in step S409), the processing proceeds to step S410. In a case where the flag f_wakeup is not 1 as a result of the determination (NO in step S409), processing of the automatic power-off is performed, and the processing in the flowchart ends.

In step S410, the control unit 101 performs setting of Wake On Lan (WOL) on the connection unit 108. The WOL is set such that, in a case where a WOL packet is received, an interrupt is generated to the control unit 101. The WOL packet is an example of an activation packet. The setting of the WOL indicates a setting for switching a WOL function from a disabled state to an enabled state. However, the setting of the WOL is not limited to the example, and for example, the setting of the WOL may indicate a setting for switching the WOL function from the enabled state to the disabled state. In a case where the sleep restoration request is received, the control unit 101 switches the setting of the WOL from the disabled state to the enabled state at a timing immediately before the operation state of the imaging apparatus 100 is switched from the activated state to the power saving state (also referred to as power saving mode). After the setting of the WOL is performed, the processing proceeds to step S411.

In step S411, the control unit 101 clears the flag f_wakeup. In other words, the control unit 101 sets the flag f_wakeup to 0 (f_wakeup=0). More specifically, the control unit 101 prevents the WOL setting from being automatically performed after the imaging apparatus 100 is activated (restored) from the power saving mode by the WOL packet. After the flag f_wakeup is cleared, the processing proceeds to step S412.

In step S412, the control unit 101 performs the automatic power-off. The imaging apparatus 100 is transitioned to the power saving mode where the imaging apparatus 100 can be restored to the activated state in response to an event issued from the outside. Thereafter, the processing proceeds to step S413. In the present exemplary embodiment, the case where the imaging apparatus 100 is transitioned to the power saving mode by the control unit 101 and is restored to the activated state in response to an event issued from the outside is described; however, a sub-central processing unit (sub-CPU) including a control unit with less power consumption may be mounted, and power supply to the control unit 101 may be stopped by the sub-CPU. In this case, if an event has been issued from the outside, an interrupt occurs the sub-CPU having a control unit with less power consumption than the control unit 101, and the control unit 101 is restored by the sub-CPU.

In step S413, the control unit 101 determines whether an interrupt by the WOL has been generated. In a case where an interrupt has been generated (YES in step S413), the processing proceeds to step S414. In a case where interrupt has not been generated (NO in step S413), the processing waits for an interrupt by the WOL.

In FIG. 3, in a case where a WOL packet 309 is transmitted from the PC 200 in an operation 308, the imaging apparatus 100 receives the WOL packet 309 via the connection unit 108 in an operation 310. Upon reception of the WOL packet, the connection unit 108 performs operation for generation an interrupt to the control unit 101.

In step S414, the control unit 101 performs processing for restoring and activating the imaging apparatus 100. To automatically perform the connection processing after restoration, the processing proceeds to step S401. After restoration and activation, a reconnection 311 (FIG. 3) is performed.

### [Processing in PC 200]

In step S501, the control unit 201 starts a connection with the imaging apparatus 100 via the connection unit 207. Thereafter, the processing proceeds to step S502.

In step S502, the control unit 201 performs connection operation to connect with the imaging apparatus 100 via the connection unit 207, and determines whether the connection has succeeded. The connection operation includes establishment of a link of the connection unit 207, logical establishment of a communication protocol via the connection unit 207, and the like. In FIG. 3, the connection 301 between the imaging apparatus 100 and the PC 109 is established. In a case where the connection has succeeded (YES in step S502), the processing proceeds to step S503.

In step S503, the control unit 201 determines whether a flag f_PCwakeup is 1. In a case where the flag f_PCwakeup is 1 as a result of the determination (YES in step S503), the processing proceeds to step S504. In a case where the flag f_PCwakeup is not 1 as the result of the determination (NO in step S503), the processing proceeds to step S505. The flag f_PCwakeup is a flag for determining whether to issue a sleep restoration request to the imaging apparatus 100 by a user instruction. The flag f_PCwakeup is an example of instruction information (restore instruction), and may be stored in a storage unit, such as the nonvolatile memory 202.

In step S504, the control unit 201 transmits a sleep restoration request to the imaging apparatus 100 via the connection unit 207. After the transmission, the processing proceeds to step S505.

In FIG. 3, the sleep restoration request 303 is transmitted to the imaging apparatus 100 via the connection unit 207 in the operation 302. The imaging apparatus 100 receives the sleep restoration request 303 via a communication path in the operation 304, and recognizes the sleep restoration request.

In step S505, the control unit 201 determines whether processing instructed by the user via the operation unit 204 has been performed. In a case where the processing instructed by the user has been performed (YES in step S505), the processing proceeds to step S506. In a case where the processing instructed by the user has not been performed (NO in step S505), the processing proceeds to step S509.

In step S506, the control unit 201 determines whether the processing instructed by the user via the operation unit 204 is a sleep restoration request. In a case where the instructed processing is a sleep restoration request (YES in step S506), the processing proceeds to step S507. In a case where the instructed processing is not a sleep restoration request (NO in step S506), the processing proceeds to step S508.

In step S507, in the case where the processing instructed by the user is a sleep restoration request in step S506, the control unit 201 sets the flag f_PCwakeup to 1 (f_PCwakeup=1), and the processing proceeds to step S503.

In step S508, in the case where the processing instructed by the user is not a sleep restoration request in step S506, the control unit 201 transmits control appropriate for the request to the imaging apparatus 100 via the connection unit 207. After the transmission, the processing proceeds to step S505. Examples of a request other than the sleep restoration request may include an imaging request and an imaging parameter change request. In other words, the request is a request for remotely operating the imaging apparatus 100 from the PC 200.

In step S509, the control unit 201 determines whether any signal has been received from the imaging apparatus 100 via the connection unit 207. In a case where a signal has been received (YES in step S509), the processing proceeds to step S510. In a case where no signal has been received (NO in step S509), the processing proceeds to step S505.

In step S510, the control unit 201 determines whether the signal received from the imaging apparatus 100 is an event in which the imaging apparatus 100 executes automatic power-off. In a case where the signal indicates the event of the automatic power-off execution (YES in step S510), the processing proceeds to step S512. In a case where the signal does not indicate the event of the automatic power-off execution (NO in step S510), the processing proceeds to step S511.

In FIG. 3, in a case where the automatic power-off execution 306 is transmitted from the imaging apparatus 100 in the operation 305, the PC 200 receives the automatic power-off execution 306 via the connection unit 207 in the operation 307.

In step S511, the control unit 201 performs processing corresponding to the signal received from the imaging apparatus 100. After the processing is performed, the processing proceeds to step S505. There is a case where the PC 200 receives an alert from the imaging apparatus 100, for example, in a case where any abnormality occurs on the imaging apparatus 100 or in a case where the recording medium has no free capacity. When the PC 200 receives the alert, for example, the control unit 201 displays the alert on the display unit 205.

In step S512, the control unit 201 determines whether the flag f_PCwakeup is 1. In other words, the control unit 201 determines whether the sleep restoration request has been previously transmitted to the imaging apparatus 100 and setting of the WOL has been performed on the imaging apparatus 100. In a case where the flag f_PCwakeup is 1 as a result of the determination (YES in step S512), the processing proceeds to step S513. In a case where the flag f_PCwakeup is not 1 (NO in step S512), the processing ends.

In step S513, the control unit 201 determines whether the processing instructed by the user via the operation unit 204 has been performed. In a case where the processing instructed by the user has been performed (YES in step S513), the processing proceeds to step S514. In a case where the processing instructed by the user has not been performed (NO in step S513), the processing waits for execution of the processing instructed by the user.

In step S514, the control unit 201 transmits the WOL packet to the imaging apparatus 100 via the connection unit 207. After the transmission, the processing proceeds to step S501 in order to perform connection processing. After restoration and activation, the reconnection 311 is performed.

As described above, the imaging apparatus 100 clears the flag f_wakeup before restoring from the power saving mode by the WOL. Therefore, when a reconnection is performed after the imaging apparatus 100 is restored to the activated state by the WOL, the flag f_wakeup has not been set, and the setting of the WOL is not performed unless the setting is remotely performed each time a reconnection is performed. On the other hand, in the PC 200, the flag f_PCwakeup is stored in the nonvolatile memory 202 after the user sets the flag f_PCwakeup. Thus, if a reconnection is performed after the imaging apparatus 100 is restored to the activated state by the WOL, the f_PCwakeup has been already enabled, and the sleep restoration request is transmitted immediately after the reconnection. Therefore, when the sleep restoration request is issued from the PC 200 in a state where the connection has been established between the imaging apparatus 100 and the PC 200, the WOL is repeatedly set after the imaging apparatus 100 is restored to the activated state by the WOL. In a case where the imaging apparatus 100 is connected to an external device terminal other than the PC 200, the setting of the WOL is not performed unless the user intentionally issues the sleep restoration request. Therefore, the WOL is set only when it is necessary.

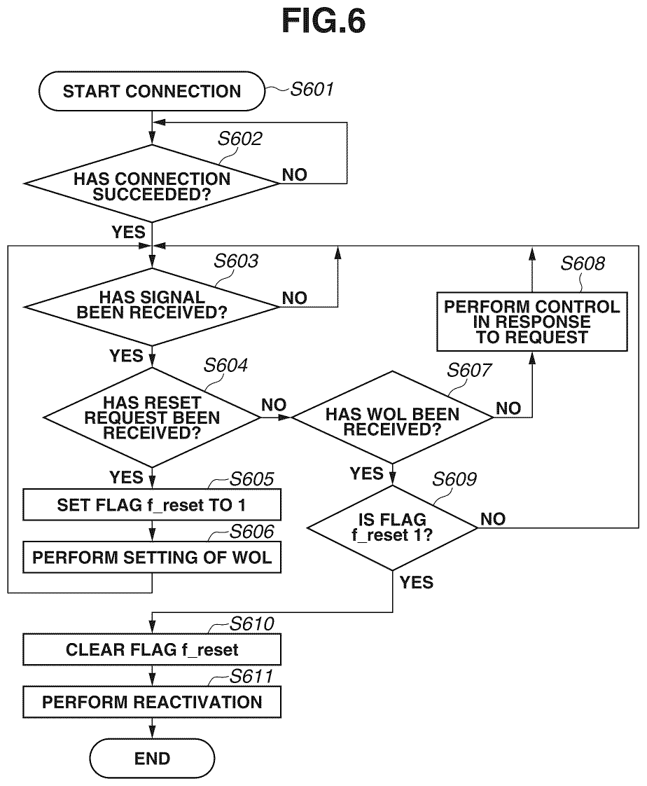

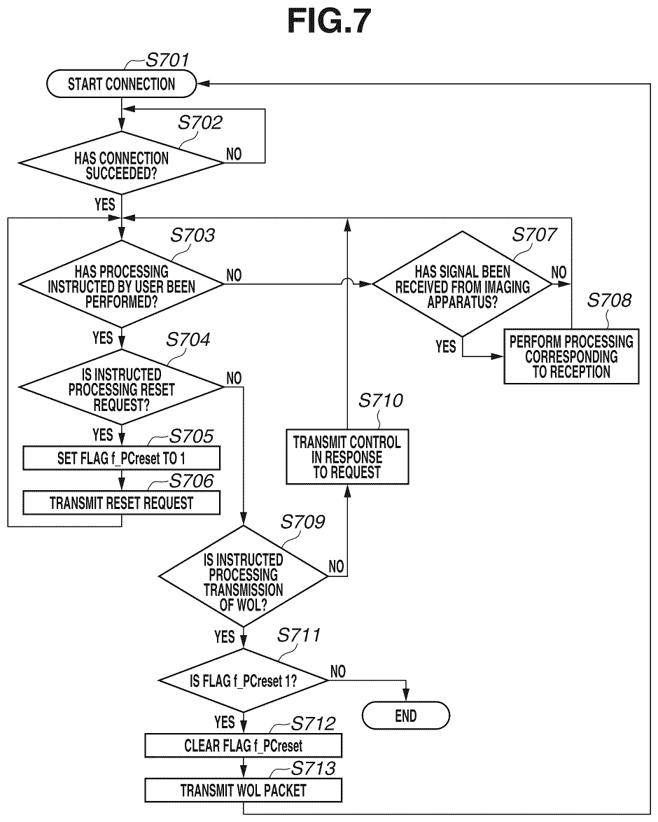

A flow of processing for resetting the imaging apparatus 100 and the PC 200 constituting the communication system according to a second exemplary embodiment of the present disclosure by using an WOL in each of the apparatuses is described with reference to FIGS. 6 and 7.

### [Processing in Imaging Apparatus 100]

In step S601, the control unit 101 starts a connection with the PC 200 via the connection unit 108. Thereafter, the processing proceeds to step S602.

In step S602, the control unit 101 performs connection operation to connect with the PC 200 via the connection unit 108, and determines whether the connection has succeeded. The connection operation includes establishment of a link of the connection unit 108, logical establishment of a communication protocol via the connection unit 108, and the like. In a case where the connection has succeeded (YES in step S602), the processing proceeds to step S603.

In step S603, the control unit 101 determines whether any signal has been received from the PC 200 via the connection unit 108. In a case where a signal has been received (YES in step S603), the processing proceeds to step S604. In a case where no signal has been received (NO in step S603), the processing waits for reception of a signal.

In step S604, the control unit 101 determines whether the signal received from the PC 200 in step S603 is a reset request. In a case where the signal is a reset request (YES in step S604), the processing proceeds to step S605. In a case where the signal is not a reset request (NO in step S604), the processing proceeds to step S607. The reset request is another example of the request information.

In step S605, in the case where the signal received from the PC 200 is a reset request in step S604, the control unit 101 sets a flag f_reset to 1 (f_reset=1), and the processing proceeds to step S606. The flag f_reset is a flag for determining whether a reset request has been issued from the PC 200. The flag f_reset is initialized to 0 (f_reset=0) at the start of the connection. The flag f_reset is stored in the work memory 104.

In step S606, the control unit 101 performs setting of a WOL on the connection unit 108. The WOL is set such that, in a case where a WOL packet is received, an interrupt is generated to the control unit 101. After the setting of the WOL is performed, the processing proceeds to step S603.

In step S607, the control unit 101 determines whether the signal received from the PC 200 is a WOL packet. In a case where a WOL packet has been received (YES in step S607), the processing proceeds to step S609. In a case where the signal is not a WOL packet (NO in step S607), the processing proceeds to step S608.

In step S608, in a case where the signal received from the PC 200 in step S603 is neither a reset request nor a WOL packet, the control unit 101 performs control appropriate for the received request. After the control appropriate for the received request is performed, the processing proceeds to step S603. Examples of the request may include an imaging request and an imaging parameter change request. In other words, the request is a request for remotely operating the imaging apparatus 100 from the PC 200.

In step S609, the control unit 101 determines whether the flag f_reset is 1. In a case where the flag f_reset is 1 as a result of the determination (YES in step S609), the processing proceeds to step S610. In a case where the flag f_reset is not 1 as the result of the determination (NO in step S609), the processing proceeds to step S603.

In step S610, the control unit 101 clears the flag f_reset. In other words, the control unit 101 sets the flag f_reset to 0 (f_reset=0). After the flag f_reset is cleared, the processing proceeds to step S611.

In step S611, the control unit 101 performs processing for reactivating the imaging apparatus 100. After the reactivation, the processing ends. However, the processing returns to step S601 in order to automatically perform connection processing after the reactivation.

### [Processing in PC 200]

In step S701, the control unit 201 starts a connection with the imaging apparatus 100 via the connection unit 207. Thereafter, the processing proceeds to step S702.

In step S702, the control unit 201 performs connection operation to connect with the imaging apparatus 100 via the connection unit 207, and determines whether the connection has succeeded. The connection operation includes establishment of a link of the connection unit 207, logical establishment of a communication protocol via the connection unit 207, and the like. In a case where the connection has succeeded (YES in step S702), the processing proceeds to step S703.

In step S703, the control unit 201 determines whether processing instructed by the user via the operation unit 204 has been performed. In a case where the processing instructed by the user has been performed (YES in step S703), the processing proceeds to step S704. In a case where the processing instructed by the user has not been performed (NO in step S703), the processing proceeds to step S707.

In step S704, the control unit 201 determines whether the processing instructed by the user through the operation unit 204 is a reset request. In a case where the instructed processing is a reset request (YES in step S704), the processing proceeds to step S705. In a case where the instructed processing is not a reset request (NO in step S704), the processing proceeds to step S709.

In step S705, in a case where the processing instructed by the user is a reset request in step S704, the control unit 201 sets a flag f_PCreset to 1 (f_PCreset=1), and the processing proceeds to step S706. The flag f_PCreset is a flag for determining whether to transmit a reset request to the imaging apparatus 100 by a user instruction. The flag f_PCreset is an example of instruction information (reset instruction), and may be stored in a storage unit, such as the work memory 203.

In step S706, the control unit 201 transmits the reset request to the imaging apparatus 100 via the connection unit 207. After the transmission, the processing proceeds to step S703.

In step S707, the control unit 201 determines whether any signal has been received from the imaging apparatus 100 via the connection unit 207. In a case where a signal has been received (YES in step S707), the processing proceeds to step S708. In a case where no signal has been received (NO in step S707), the processing proceeds to step S703.

In step S708, the control unit 201 performs processing corresponding to the signal received from the imaging apparatus 100. After the processing is performed, the processing proceeds to step S703. There is a case where the PC 200 receives an alert from the imaging apparatus 100, for example, in a case where any abnormality occurs on the imaging apparatus 100 or in a case where the recording medium has no free capacity. When the PC 200 receives the alert, for example, the control unit 201 displays the alert on the display unit 205.

In step S709, the control unit 201 determines whether the processing instructed by the user via the operation unit 204 is a WOL transmission request. In a case where the instructed processing is a WOL transmission request (YES in step S709), the processing proceeds to step S711.

In a case where the instructed processing is not a WOL transmission request (NO in step S709), the processing proceeds to step S710.

In step S710, in the case where the processing instructed by the user is not a WOL transmission request, the control unit 201 transmits control appropriate for the request to the imaging apparatus 100 via the connection unit 207. After the transmission, the processing proceeds to step S703. Examples of the request other than the WOL transmission request may include an imaging request and an imaging parameter change request. In other words, the request is a request for remotely operating the imaging apparatus 100 from the PC 200.

In step S711, the control unit 201 determines whether the flag f_PCreset is 1. In other words, the control unit 201 determines whether the reset request has been previously transmitted to the imaging apparatus 100 and setting of the WOL has been performed on the imaging apparatus 100. In a case where the flag f_PCreset is 1 as a result of the determination (YES in step S711), the processing proceeds to step S712. In a case where the flag f_PCreset is not 1 (NO in step S711), the processing ends.

In step S712, the control unit 101 clears the flag f_PCreset. In other words, the control unit 101 sets the flag f_PCreset to 0 (f_PCreset=0). After the flag f_PCreset is cleared, the processing proceeds to step S713.

In step S713, the control unit 201 transmits the WOL packet to the imaging apparatus 100 via the connection unit 207. After the transmission, the processing proceeds to step S701 in order to perform connection processing.

As described above, the imaging apparatus 100 clears the flag f_reset before resetting is performed by the WOL. Therefore, when a reconnection is performed after the imaging apparatus 100 is restored to the activated state by the WOL, the flag f_reset has not been set, and the setting of the WOL is not performed unless the setting is remotely performed each time a reconnection is performed. On the other hand, the PC 200 also clears the flag f_PCreset (discards a reset instruction) before the WOL is transmitted. Thus, after a reconnection is performed, the flag f_PCreset has been disabled and a reset request is not transmitted. Therefore, in the connection between the imaging apparatus 100 and the PC 200, the WOL is not set unless the user intentionally transmits a reset request from the PC 200 after a connection is established. Therefore, the imaging apparatus 100 cannot be easily reset from another external device terminal.

Although the exemplary embodiments of the present disclosure are described above, the present disclosure is not limited to these exemplary embodiments, and can be modified and changed in various ways within the scope of the spirit.

### Other Exemplary Embodiments

The present disclosure can be realized by supplying software (programs) for realizing the functions of the above-described exemplary embodiments to a system or an apparatus through a network or various kinds of storage media, and causing a computer (or a control unit, a microprocessor unit (MPU), etc.) of the system or the apparatus to read out and execute program codes. In this case, the programs and the storage medium storing the programs are also included in the present disclosure.

Although the present disclosure is described in detail based on the exemplary embodiments, the present disclosure is not limited to these specific exemplary embodiments, and various forms without departing from the spirit of the present disclosure are also included in the present disclosure. The above-described exemplary embodiments may be partially combined as appropriate.

The functional units in each of the above-described exemplary embodiments (modifications) may be or may not be individual hardware. The functions of the two or more functional units may be realized by common hardware. Each of the plurality of functions of one functional unit may be realized by individual hardware. Two or more functions of one functional unit may be realized by common hardware. Each of the functional units may be or may not be realized by hardware, such as an application specific integrated circuit (ASIC), a field programmable gate array (FPGA), and a digital signal processor (DSP). For example, the apparatus may include a processor and a memory (storage medium) storing control programs. Further, the functions of at least a part of the functional units included in the apparatus may be realized when the processor reads out the control programs from the memory and executes the control programs.

The present disclosure can be realized by supplying programs for realizing one or more functions of the above-described exemplary embodiments to a system or an apparatus through a network or a storage medium, and causing one or more processors of a computer in the system or the apparatus to read out and execute the programs. Further, the present disclosure can be realized by a circuit (e.g., ASIC) for realizing one or more functions.

### [Configuration 1]

A communication system including a first communication apparatus and a second communication apparatus, in which the first communication apparatus includes a communication unit configured to transmit request information for requesting to switch a WOL function to an enabled state or a disabled state and an activation packet to the second communication apparatus based on instruction information set by a user, in which the second communication apparatus includes a communication unit configured to receive the request information and the activation packet from the first communication apparatus, and a control unit configured to switch the WOL function to the enabled state or the disabled state based on the request information received from the first communication apparatus, and in which, in a case where the activation packet is received when an operation state of the second communication apparatus is a power saving state and the WOL function is enabled, the control unit performs processing for activating the second communication apparatus from the power saving state and switches the WOL function of the second communication apparatus to the disabled state.

### [Configuration 2]

The communication system according to configuration 1, in which the first communication apparatus further includes a storage unit configured to store the instruction information set by the user.

### [Configuration 3]

The communication system according to configuration 2, in which, in a case where the instruction information is stored in the storage unit after a connection between the first communication apparatus and the second communication apparatus is started, the communication unit of the first communication apparatus transmits the request information based on the instruction information to the second communication apparatus. [Configuration 4]

The communication system according to configuration 2 or 3, in which the instruction information includes a restore instruction for switching the WOL function to the enabled state at a timing immediately before the operation state of the second communication apparatus is switched from an activated state to the power saving state. [Configuration 5]

The communication system according to configuration 3 or 4, in which the instruction information includes a reset instruction for switching the WOL function of the second communication apparatus to the enabled state at a timing when the operation state of the second communication apparatus is an activated state.

### [Configuration 6]

The communication system according to configuration 5, in which the control unit of the second communication apparatus switches the WOL function to the enabled state at a timing immediately after request information based on the reset instruction is received from the first communication apparatus.

### [Configuration 7]

The communication system according to configuration 6, in which, in a case where the activation packet is received when the operation state of the second communication apparatus is the activated state and the WOL function is enabled, the control unit of the second communication apparatus performs processing for reactivating the second communication apparatus.

### [Configuration 8]

The communication system according to configuration 7, in which the first communication apparatus further includes a control unit configured to, in a case where the instruction information including the reset instruction is stored in the storage unit, discard the instruction information including the reset instruction from the storage unit at a timing when the activation packet is transmitted to the second communication apparatus.

### [Configuration 9]

The communication system according to any one of configurations 1 to 8, in which the second communication apparatus is a camera.

According to the present disclosure, it is possible to provide the technique for enabling a setting to restore a communication apparatus to an activated state using a WOL at a timing instructed by a user by performing remote control from an external device terminal. Further, it is possible to provide a technique for restoring the communication apparatus to the activated state by the remote control using a WOL packet only from the external device terminal that has set the WOL.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-145934, filed Sep. 8, 2023, which is hereby incorporated by reference herein in its entirety.

What is claimed is:

1. A communication system including a first communication apparatus and a second communication apparatus,
wherein the first communication apparatus includes,
a communication unit configured to transmit request information for requesting to switch a Wake On Lan (WOL) function to an enabled state or a disabled state and an activation packet to the second communication apparatus based on instruction information set by a user,
wherein the second communication apparatus includes,
a communication unit configured to receive the request information and the activation packet from the first communication apparatus, and
a control unit configured to switch the WOL function to the enabled state or the disabled state based on the request information received from the first communication apparatus, and
wherein, in a case where the activation packet is received when an operation state of the second communication apparatus is a power saving state and the WOL function is enabled, the control unit performs processing for activating the second communication apparatus from the power saving state and switches the WOL function of the second communication apparatus to the disabled state.

2. The communication system according to claim 1, wherein the first communication apparatus further includes a storage unit configured to store the instruction information set by the user.

3. The communication system according to claim 2, wherein, in a case where the instruction information is stored in the storage unit after a connection between the first communication apparatus and the second communication apparatus is started, the communication unit of the first communication apparatus transmits the request information based on the instruction information to the second communication apparatus.

4. The communication system according to claim 3, wherein the instruction information includes a reset instruction for switching the WOL function of the second communication apparatus to the enabled state at a timing when the operation state of the second communication apparatus is an activated state.

5. The communication system according to claim 4, wherein the control unit of the second communication apparatus switches the WOL function to the enabled state at a timing immediately after request information based on the reset instruction is received from the first communication apparatus.

6. The communication system according to claim 5, wherein, in a case where the activation packet is received when the operation state of the second communication apparatus is the activated state and the WOL function is enabled, the control unit of the second communication apparatus performs processing for reactivating the second communication apparatus.

7. The communication system according to claim 6, wherein the first communication apparatus further includes a control unit configured to, in a case where the instruction information including the reset instruction is stored in the storage unit, discard the instruction information including the reset instruction from the storage unit at a timing when the activation packet is transmitted to the second communication apparatus.

8. The communication system according to claim 2, wherein the instruction information includes a restore instruction for switching the WOL function to the enabled state at a timing immediately before the operation state of the second communication apparatus is switched from an activated state to the power saving state.

9. The communication system according to claim 1, wherein the second communication apparatus is a camera.
